(19) United States
(12) Patent Application Publication
(10) Pub. No.: US 2025/0159309 A1
(43) Pub. Date: May 15, 2025

(54) AN AUGMENTED REALITY INTERFACE FOR WATCHING LIVE SPORT GAMES

(71) Applicant: B.G. NEGEV TECHNOLOGIES AND APPLICATIONS LTD., AT BEN-GURION UNIVERSITY, Beer-Sheva (IL)

(72) Inventor: Jihad EL-SANA, Lakia (IL)

(73) Assignee: B.G. NEGEV TECHNOLOGIES AND APPLICATIONS LTD., AT BEN-GURION UNIVERSITY, Beer-Sheva (IL)

(21) Appl. No.: 18/838,644

(22) PCT Filed: Feb. 16, 2023
(86) PCT No.: PCT/IL2023/050171

§ 371 Date: Aug. 15, 2024

(51) Int. Cl. H04N 21/81; G06T 7/246; G06T 7/292; G06T 7/73; G06T 13/40; G06T 17/00; H04N 21/218; H04N 21/234; H04N 21/414; H04N 21/431; H04N 21/472

(52) U.S. Cl. CPC H04N 21/8146; G06T 7/246; G06T 7/292; G06T 7/73; G06T 13/40; G06T 17/00; H04N 21/21805; H04N 21/23418; H04N 21/4312; H04N 21/47217; G06T 2200/24; G06T 2207/10016; G06T 2207/20084; G06T 2207/30196; G06T 2207/30228; H04N 21/41407

(57) ABSTRACT

A system for controlling the rendering of a broadcasted game at a spectator side, comprising a set of cameras deploying around a real game field a memory for storing acquired video footages being a sequence of frames of the real game field and players in the real game; a 3D model of each player, generated before the game according to the performance of the each player, within previously taken video streams; an object detection module comprising at least one processor which is adapted to receive and processes the video footages; identify the each player and the real game field in each frame of the video footages; determine the location of each player on the game field in each frame; extract skeletal and skin features of each player from the video footages using deep learning models; generate 3D avatars for all players using the 3D model and the extracted features, to animate the respective 3D avatars; continuously track the location and movements of each player over the acquired video footages; determine pose features of each player over time. A transmitter transmits data related to the game field, the location data and the 3D avatars to a software application at the spectator side and a computerized terminal device at the spectator side executes the software application to thereby generate a synthesized game field and animate the 3D avatars according to pose features of each player.

### CROSS-REFERENCED APPLICATIONS

This application is a national stage application of International Application No. PCT/IL2023/050171, filed on Feb. 16, 2023, which claims priority to U.S. Provisional Application No. 63/310,609, filed on Feb. 16, 2022, both of which are incorporated by reference thereto in there entities.

### FIELD OF THE DISCLOSURE

The present disclosure relates to the field of broadcasting live sport events. More particularly, the present disclosure relates to a system and method for allowing an observer who watches a broadcasted live sport events to manipulate the rendering of the broadcasted event at the client side in real-time.

### BACKGROUND OF THE DISCLOSURE

Watching sports events, such as games, and competitions is among the main entertainment avenues that attract millions of people worldwide. Currently, spectators (users) observe these games and other sport events on-site, or watch them remotely, over 2D displays. Generally, the footage of these games and events is taken by several video cameras which are deployed in the game site, so it is possible to switch between cameras to obtain different views. However, in both cases, the spectator often has a limited view of the game, which is dictated by the location of his seat in the stadium or the broadcasting camera's current view. Therefore, the user's ability to select or influence the view parameters, such as direction, field of view, and zoom level, is limited. For example, goals in soccer games are sometimes seen from behind the net, which is an interesting point of view. However, this view requires deploying a dedicated camera at this particular location.

Another limitation of existing game broadcasting systems relates to the ability of a spectator to view the game from different points-of-view, since these systems require large processing power and extensive transmission of data to the spectator side.

Several existing broadcasting systems include many cameras that are deployed in the game field, to generate synchronize novel views and reconstruct the game area with the players [2, 3, 4, 5, 6]. These systems create views that were not captured by any of the cameras. However, in order to obtain accurate construction, these systems require using many cameras at high resolution that are finely synchronized. Nevertheless, the reconstruction is not always complete due to the fact that the amount of data is huge and requires extensive computational resources to be processed.

Mixed (Augmented/Virtual) reality interfaces allow viewers to determine the view parameters as desired. However, generating content for these technologies is often a challenging task, which is similar to preparing content for a video game or a movie. To obtain high-quality content, one needs to write a script, design scenes, objects, and characters, and animate them according to the script. In addition, these objects and characters must be registered on the real-world coordinates.

It is therefore an object of the present disclosure to provide a system and method for allowing a spectator who watches a broadcasted live sport events to manipulate the rendering of the broadcasted event at the client side in real-time.

It is another object of the present disclosure an object of the present disclosure to provide a system and method for allowing a spectator who watches a broadcasted live sport events to manipulate the rendering of the broadcasted event at the client side in real-time, by using an Augmented Reality (AR) interface.

It is another object of the present disclosure to provide a system and method for controlling the rendering of a broadcasted sport event at the client side, as desired by the spectator.

It is a further object of the present disclosure to provide a system and method for controlling the rendering of a broadcasted sport event at the client side, using low bandwidth resources.

It is still another object of the present disclosure to provide a system and method for controlling the rendering of a broadcasted sport event at the client side, from any point of view, at any zoom level anytime, including illumination, scene effects, and playback of previous events.

Other objects and advantages of the disclosure will become apparent as the description proceeds.

### SUMMARY

A method for controlling the rendering of a broadcasted game (such as a sport game) at a spectator side, comprising the step of:
a) deploying a set of cameras around a real game field;
b) acquiring, in real time, video footages being a sequence of frames of the real game field and players in the real game;
c) before the game, generating a 3D model of each player according to his performance within previously taken video streams;
d) identifying the each player and the real game field in each frame of the video footages, by an object detection module that receives and processes the video footages;
e) determining the location of each player on the game field in each frame;
f) extracting skeletal and skin features of each player from the video footages using deep learning models;
g) generating 3D avatars for all players using the 3D model and the extracted features, to animate the respective 3D avatars;
h) continuously tracking the location and movements of each player over the acquired video footages;
i) determining pose features of each player over time;
j) transmitting data related to the game field, the location data and the 3D avatars to a software application at the spectator side; and
k) generating, on a computerized terminal device that executes the software application at the spectator side, a synthesized game field and animating, by the software application, the 3D avatars according to pose features of each player.

The acquired video footages may comprise a real game ball.

Each spectator may use an interface (such as a VR user interface if the synthesized game is rendered as a 3D game) of the software application to manipulate the rendering of the synthesized game by:
a) changing the point of view during the game;
b) changing the direction of view during the game;
c) stop and resume the game;
d) re-playing selected segments of the game; and
e) controlling the zoom level to get close-up views from any direction and from any desired angle.

The pose features may comprise:
a) skeletal features extracted using a deep learning model, which determines key points form the character's geometric skeleton of each player; and
b) skin features including the deformation of the player's clothes.

The spectator at the client side may view the 3D synthesized game on a 2D display screed, or by using a 3D VR goggle/smart glasses.

The spectator at the client side may view the 3D synthesized game without any intervention.

An animation model may be used for filling gaps of missing players from one or more video footage frames, to provide smooth animation of the avatars.

In one aspect, the 3D model of the player is forced to have the same pose and position in the virtual game field, according to the actual game field.

The movements of every player may be tracked over the available set of cameras, while selecting and the best view in terms of visibility and coherence.

In one aspect, upon detecting a player by footage from a proximal camera, further detecting and tracking the player using distal cameras.

A deep learning model may be adapted to extract features from each player using Convolutional Neural Network (CNN) and applies transformers to map these features to a skeleton and skin features.

The exact location of each player or an object in the game field may be calculated using data from different cameras.

A transformer module may be used, which is adapted to:
a) receive a collection of features in each frame and translates the features to a pose of each player in each frame, thereby determining the poses variation over time; and
b) output, for each frame, a skeletal representation of the pose of each player in that frame.

The extracted pose features may be compressed before being streamed to the remote spectators at the client side.

The streaming architecture may comply with:
a) HTTP specification;
b) Web Real-Time Communications (WebRTC);
c) HTTP Live Streaming (HLS);
d) Dynamic Adaptive Streaming over HTTP (MPEG-DASH).

The player's model may be obtained using manual modeling, 3D scanning and model fitting.

A deep learning model that determines the sequence of actions/poses may be applied to fill missing gaps in the synthesized game.

Deep learning techniques may be used to apply character pose estimation and extract skeletal and skin pose features.

A system for controlling the rendering of a broadcasted game at a spectator side, comprising:
a) a set of cameras deploying around a real game field;
b) a memory for storing:
   b.1) acquired video footages being a sequence of frames of the real game field and players in the real game;
c) a 3D model of each player, generated before the game according to the performance of the each player, within previously taken video streams;
d) an object detection module comprising at least one processor which is adapted to:
   d.1) receive and processes the video footages;
   d.2) identify the each player and the real game field in each frame of the video footages;
   d.3) determine the location of each player on the game field in each frame;
   d.4) extract skeletal and skin features of each player from the video footages using deep learning models;
   d.5) generate 3D avatars for all players using the 3D model and the extracted features, to animate the respective 3D avatars;
   d.6) continuously track the location and movements of each player over the acquired video footages;
   d.7) determine pose features of each player over time;
e) a transmitter for transmitting data related to the game field, the location data and the 3D avatars to a software application at the spectator side; and
f) a computerized terminal device at the spectator side that executes the software application to thereby generate a synthesized game field and animate the 3D avatars according to pose features of each player.

The system may further comprise a VR user interface for allowing each spectator using the software application on his terminal device, to manipulate the rendering of the synthesized game by:
a) changing the point of view during the game;
b) changing the direction of view during the game;
c) stop and resume the game;
d) re-playing selected segments of the game;
e) controlling the zoom level to get close-up views from any direction and from any desired angle.

The memory may further store an animation model for filling gaps of missing players from one or more video footage frames, to provide smooth animation of the avatars.

The memory may further store a deep learning model that extracts features from each player using Convolutional Neural Network (CNN) and applies transformers to map these features to a skeleton and skin features.

The system may further comprise a transformer module, which is adapted to:
c) receive a collection of features in each frame and translates the features to a pose of each player in each frame, thereby determining the poses variation over time;
d) output, for each frame, a skeletal representation of the pose of each player in that frame.

The memory may further store a deep learning model that determines the sequence of actions/poses is applied to fill missing gaps in the synthesized game.

The terminal device may be:
a smartphone;
a tablet;
a desktop computer;
a laptop computer;
a smart TV.

### BRIEF DESCRIPTION OF THE DRAWINGS

The above and other characteristics and advantages of the disclosure will be better understood through the following illustrative and non-limitative detailed description of preferred embodiments thereof, with reference to the appended drawings, wherein:

FIG. 1 schematically illustrates a system for generating a synthesized sport event at the client side, which accurately represents a real sport event, according to an embodiment of the disclosure; and

FIG. 2 schematically illustrates the architecture of the deep learning model and its main operations in an example of a soccer game.

### DETAILED DESCRIPTION OF THE DISCLOSURE

The present disclosure proposes a system and method for allowing a spectator who wishes to watch a broadcasted live sport event to manipulate the rendering of the broadcasted event at the client side in real-time and as desired by the spectator, based on video footages that are taken by several video cameras that are deployed in a real game field. At the client (the spectator) side, the spectator uses an interface to manipulate 2D rendering of the game. The spectator can optionally use an Augmented Reality (AR) interface to manipulate 3D rendering of the game. The spectator (client) can render a broadcasted sport event at the client side, from any point of view, at any zoom level anytime, including playback of previous events. This is done by detecting and identifying each player and extracting pose features of every player in the video stream. Then, the extracted features are applied to predefined 3D models of the respective players within a 3D synthesized (virtual) game in sporting game field (the virtual 3D game is synthesized by a dedicated software application at the client side, as will be described later on). The dedicated software is adapted to be installed and to run on a terminal device any the client side, such as a smartphone, a tablet, a desktop computer, a laptop computer or a smart TV. The dedicated software (or application) comprises a user interface, through which, the spectator can manipulate the 3D rendering of the synthesized game, according to his preferences.

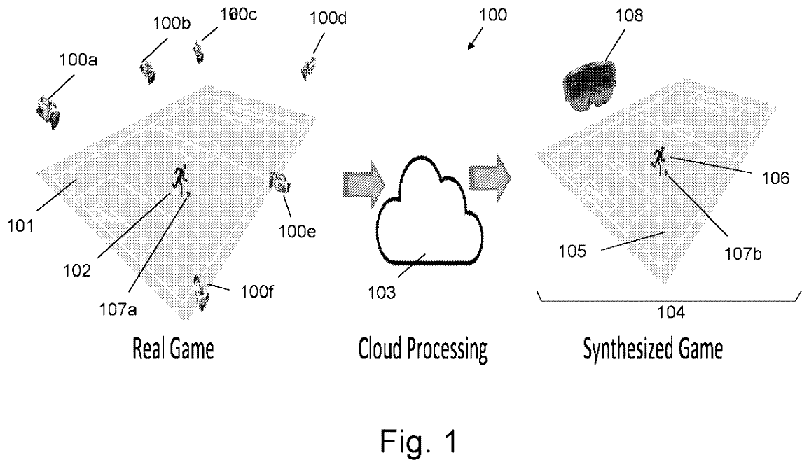

FIG. 1 schematically illustrates a system 100 for generating of a synthesized sport event at the client side, which accurately represents a real sport event, according to an embodiment of the disclosure. A set of cameras 100a-100f is deployed around the real game field. The deployed cameras 100a-100f acquire video footages of the game field, the real ball 107a and the players 102, such that the players and the ball 107a can be identified in any shot frame of the video footages. A cloud processing module 103 receives and processes the video data collected from the cameras. The processing module 103 feeds a software application 104 at the client (the spectator) side (alone, or in combination with a remote server that provides the necessary computational resources), which generates a synthesized game field 105 (that is an accurate reconstruction of the real game field), a synthesized virtual ball 107b and an accurate animated 3D avatar 106 for each player 102. Each synthesized 3D avatar 106 represents a corresponding real player that appears in the video footages.

The processing module 103 uses video footages taken by multiple cameras, to detect players and determine which camera has the best view, from which the pose parameters are extracted. Then the processing module 103 extracts the skeletal and skin features for each player from the video stream using deep learning models and applies the extracted features to animate the respective 3D avatars. The system detects and identifies each player 102 and tracks his location and movements over the acquired video stream. The system 100 detects and tracks all the players continuously, since a player may appear and disappear within the video stream over the game.

The system 100 detects each individual player and extract two classes of pose features: skeletal features and skin features. The skeletal features are extracted using a deep learning model, which determines key points form the character's (player's) geometric skeleton of each player. In parallel, a deep learning model obtains pose features from the player's skin features, including the deformation of the player's clothes.

An accurate 3D virtual game is thereby synthesized on a server by a dedicated software application installed therein, including a synthesized game field 105. The avatar 106 of each player 102 is animated by the application using the 3D model of the player (according to his performance within the video stream), the extracted pose features and the character's (player's) animation model. The client side receives the synthesized data and at each step, the client receives the pose, the position, and skin parameters of every player and renders the model, using the client's view parameters.

The spectator at the client side may view the 3D synthesized game on a 2D display screed, or use a 3D VR goggle (or smart glasses) 108. This is done at the server side. The client side receives this synthesize data first. Then at each step the client receives the pose, position, and skin params of every player and renders the model using the client's view parameters.

The software application 104 at the client (the spectator) side has a user interface which allows any interested spectator to manipulate and change his point of view and direction of view during the game, stop and resume the game and re-play of selected segments of the game. For example, the spectator may virtually position his point of view on the synthesized game field at any location with respect to the game field, and control the zoom level to get close-up views from any direction and from any desired angle. Upon viewing a goal in soccer games, the spectator can position his point of view behind the net, even though there is no camera deployed behind the net in the real game field. He can also virtually view the game from above the game field, like he is hovering on a moving drone above the game field. The spectator may even virtually view the game in real-time from any point on the game field. This allows gaining a significant advantage over conventional video broadcasting, during which the spectator can view the game only as the transmitting side determined. Another advantage is saving bandwidth—instead of transmitting video data, the transmitted content is the 3D model of the each player, the extracted pose features and the character's (player's) animation model, that allow the software application 104 at the client side to synthesize the game, in real-time, at the client side. This requires much less transmission bandwidth.

The transmitted content is broadcasted simultaneously to all remote spectators, while each spectator is free to manipulate and change the synthesized game using user interface of the software application 104, according to his preferences.

Alternatively, the spectator may view the synthesized game without any intervention (in this case the synthesized game will be essentially identical to the real game).

The extracted pose features may not be sufficient to determine the avatar's pose at each frame due to partial occlusion or false pose detection of the corresponding player. In this case, the animation model will fill the gap and provide smooth animation of the avatar 106.

An accurate 3D model of every player 102 in the game may be generated or provided according to currently available modeling and animation technologies, such as FIFA games from Electronic Arts [1]. This way, viewing these games within an augmented reality framework in real-time becomes feasible.

The proposed system 100 extracts accurate pose features from each player and applies them, in real-time, to the 3D model of the player, thereby forcing the 3D model of the player to have the same pose and position in the virtual game field, according to the actual game field.

Currently, it is feasible to generate the 3D character models of every player in the game field at high accuracy, as well as animating these 3D character models. Animating algorithms apply various techniques ranging from physics-based animation and inverse kinematics to 3D skeletal animation and rigging.

### Pose Feature Extraction

Detection and analysis of human characters used deep learning technologies, which improved character detection [9], pose estimation [7,8], and tracking [10].

The system provided by the present disclosure applies multi-character (each player is represented by a corresponding character or avatar) detection and tracking, to track the movements of every player over the available set of cameras and select the best view in terms of visibility and coherence. Deep learning techniques are used to apply character pose estimation and extract skeletal and skin pose features. Upon detecting a player, e.g., by footage from a proximal camera, this player can be further detected and tracked (by detecting his location in the game field and his poses) using distal cameras.

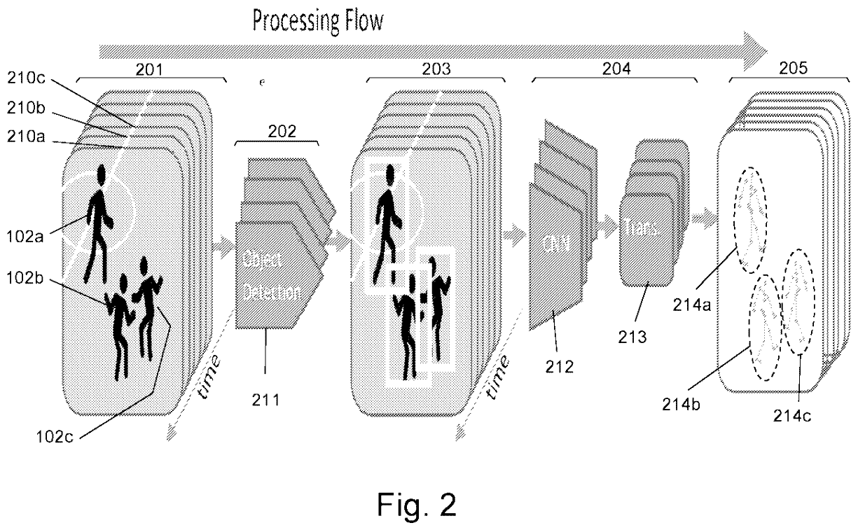

A deep learning model is used to generate, for each player, a sequence of a 3D skeleton and skin features from a sequence of frames. The model extracts features from each player using Convolutional Neural Network (CNN) and applies transformers to map these features to a skeleton and skin features. It is designed to utilize temporal coherence among the features of each player throughout the sequence. FIG. 2 schematically illustrates the architecture of the deep learning model and its main operations in an example of a soccer game.

At the first step 201, the deployed cameras 100a, . . . , 100f acquire video footages of the game field, the players and the ball 107a (if exists in the game) at least 24 frames (201a, 201b, . . . ) per second. In this example, a frame 210a contains three players, 102a, 102b and 102c. At the next step 202, each frame is fed into an object detection module 211 that at step 203, detects and identifies the ball 107a and each of the plyers (102a, 102b and 102c) that appear within the frame (210a), for example, using face recognition, skin recognition (for example, the skin may include the shirt of the player with his personal number), as well as identifying typical movement patterns (such as the way he runs, the way he dribbles with the ball 107a and the way he kicks the ball 107a). The object detection module 211 also identifies the location of the ball in each frame.

In order to determine the location of each player and of the ball 107a, data from different frames taken of video footages taken from different cameras are required. This way, the exact location of each player (or an object) in the game field can be calculated.

At step 204, the position of each player is extracted by a CNN module 212 and a transformer module 213, which use a skeletal representation for each player. The CNN module 212 processes the video footage data and applies feature extraction to determine the skeletal representation of each player in each frame, to learn how the skeletal representation of each player moves. The transformer module 213 receives the collection of features in each frame (as an input vector) and translates these features to a pose of each player in each frame (so as to determine the poses variation over time). At the next step 205, the transformer module 213 outputs, for each frame, a skeletal representation of the pose of each player in that frame. For example, 2D skeletal representations 214a, 214b and 214c correspond to players 102a, 102b and 102c, respectively, in frame 210a. This process is repeated for all the frames in the acquired video footage, while generating 3D skeletal representations.

At the next step, the 3D poses of the skeleton that were constructed using the extracted pose features are compressed and streamed to remote spectators at the client side. The skeleton representations may be sent along with the 3D poses, or may already be at the client side.

The streaming architecture can comply, for example, with HTTP specifications to support streaming over the internet. Streaming is performed using the same methodology of video streaming, such as Web Real-Time Communications (WebRTC—a source project that enables real-time voice, text and video communications capabilities between web browsers and devices), HTTP Live Streaming (HLS—is a widely used video streaming protocol that can run on almost any server and is supported by most devices. HLS allows client devices to seamlessly adapt to changing network conditions by raising or lowering the quality of the stream), and Dynamic Adaptive Streaming over HTTP (MPEG-DASH: an adaptive bitrate streaming technique that enables high quality streaming of media content over the Internet delivered from conventional HTTP web servers. MPEG-DASH works by breaking the content into a sequence of small segments, which are served over HTTP).

Similarly, the stream of pose features may be split into chunks of several seconds, compressed, and then transmitted. Each chunk has its index and additional attributes to enable reconstructing the stream correctly on the client-side and adapting to various display sizes, client processing power, and the quality of the communication channel, over which the 3D skeletal representations is transmitted to the client side.

The 3D model of each player (his avatar) is generated and animated, in order to generate a 3D avatar for each player. The player's model may be obtained using a variety of available techniques, ranging from manual modeling, up to 3D scanning and model fitting. The generated models are represented using, for example, the Skinned Multi-Person Linear (SMPL) body model (which is a realistic 3D model of the human body that is based on skinning and blend shapes and is learned from thousands of 3D body scans), which enables dynamic animation characters by manipulating their skeleton [11]. In addition, deep learning is used to obtain smooth, accurate, and realistic animation of the virtual characters of the player.

To display the game within an augmented reality framework, the field should be rendered on a sufficiently large surface, ranging from a tabletop (tabletop games are games that are normally played on a table, or other flat surface), a floor/wall of a room, or in open space. The streamed data that is received by the spectator at the client side, includes the position and pose features of every player. The streamed data contains sufficient information to position a corresponding 3D avatar for each player, in the same place and at the exact poses of that player, as in the video footage taken by the deployed cameras at the real game field.

The streamed data may include gaps resulting from packet loss or the extraction of inaccurate pose data. To solve this problem, a repository of player actions (represented as sequence of poses) is embedded in a directed graph, to fill these gaps, based on the fact that an edge on the graph connects two actions that can follow each other.

A deep learning model that determines the sequence of actions (a sequence of poses) is applied to fill the missing gap. This may require a delay of millisecond, which is acceptable in live broadcasting.

The above examples and description have of course been provided only for the purpose of illustrations, and are not intended to limit the disclosure in any way. As will be appreciated by the skilled person, the disclosure can be carried out in a great variety of ways, employing more than one technique from those described above, all without exceeding the scope of the disclosure.

### REFERENCES

1. Electronic Arts, https://www.ea.com.
2. Intel True View, https://www.intel.com/content/www/us/en/sports/technology/true-view.html
3. 0. Grau, A. Hilton, J. A. Kilner, G. Miller, T. Sargeant, J. Starck, 0. Grau, A. Hilton, G. Miller, and T. J. Sargeant. A free-viewpoint video system for visualization of sport scenes, In IBC, 2006.
4. 0. Grau, G. A. Thomas, A. Hilton, J. A. Kilner, and J. Starck. A robust free-viewpoint video system for sport scenes. 3DTV, 2007.
5. J. Guillemaut, J. Kilner, and A. Hilton. Robust graph-cut scene segmentation and reconstruction for free-viewpoint video of complex dynamic scenes. In ICCV, 2009.
6. J.-Y. Guillemaut and A. Hilton. Joint multi-layer segmentation and reconstruction for free-viewpoint video applications. IJCV, 2011. G. Pavlakos, X. Zhou, K.
7. G. Derpanis, and K. Daniilidis. Harvesting multiple views for marker-less 3d human pose annotations. In CVPR, 2017.
8. L. Pishchulin, E. Insafutdinov, S. Tang, B. Andres, M. Andriluka, P. Gehler, and B. Schiele. Deepcut: Joint subset partition and labeling for multi person pose estimation. In CVPR, 2016.
9. Lan, W., Dang, J., Wang, V. and Wang, S., 2018 August. Pedestrian detection based on YOLO network model. In 2018 IEEE international conference on mechatronics and automation (ICMA) (pp. 1547-1551). IEEE.
10. Liu, S., Liu, D., Srivastava, G., Potap, D. and Wozniak, M., 2020. Overview and methods of correlation filter algorithms in object tracking. Complex & Intelligent Systems, pp.1-23.
11. Loper, Matthew, et al. “SMPL: A skinned multi-person linear model.” ACM transactions on graphics (TOG) 34.6 (2015): 1-16.

1. A method for controlling the rendering of a broadcasted game at a spectator side, comprising:
a) deploying a set of cameras around a real game field;
b) acquiring, in real time, video footages being a sequence of frames of said real game field and players in said real game;
c) before said game, generating a 3D model of each player according to his performance within previously taken video streams;
d) identifying said each player and said real game field in each frame of said video footages, by an object detection module that receives and processes said video footages;
e) determining the location of each player on said game field in each frame;
f) extracting skeletal and skin features of each player from said video footages using deep learning models;
g) generating 3D avatars for all players using said 3D model and said extracted features, to animate the respective 3D avatars;
h) continuously tracking the location and movements of each player over the acquired video footages;
i) determining pose features of each player over time;
j) transmitting data related to said game field, the location data and said 3D avatars to a software application at the spectator side; and
k) generating, on a computerized terminal device that executes a software application at said spectator side, a synthesized game field and animating, by said software application, said 3D avatars according to pose features of each player.

2. A method according to claim 1, further comprising one or more of the following steps: acquiring video footages of a real game ball.

3. A method according to claim 1, further comprising allowing each spectator a VR user interface of the software application to manipulate the rendering of the synthesized game by:
a) changing the point of view during the game;
b) changing the direction of view during said game;
c) stop and resume said game;
d) re-playing selected segments of said game;
e) controlling the zoom level to get close-up views from any direction and from any desired angle.

4. A method according to claim 1, wherein the pose features comprise:
a) skeletal features extracted using a deep learning model, which determines key points form the character's geometric skeleton of each player; and
b) skin features including the deformation of the player's clothes.

5. A method according to claim 1, wherein the spectator at the client side views the 3D synthesized game on a 2D display screed, or by using a 3D VR goggle/smart glasses or the 3D synthesize intervention.

6. (canceled)

7. (canceled)

8. A method according to claim 1, wherein the 3D model of the player is forced to have the same pose and position in the virtual game field, according to the actual game field.

9. A method according to claim 1, wherein the movements of every player is tracked over the available set of cameras, while selecting and the best view in terms of visibility and coherence.

10. (canceled)

11. A method according to claim 1, wherein a deep learning model extracts features from each player using Convolutional Neural Network (CNN) and applies transformers to map these features to a skeleton and skin features.

12. (canceled)

13. A method according to claim 1, wherein a transformer module is adapted to:
a) receive a collection of features in each frame and translates said features to a pose of each player in each frame, thereby determining the poses variation over time;
b) output, for each frame, a skeletal representation of the pose of each player in that frame.

14. (canceled)

15. (canceled)

16. A method according to claim 1, wherein the player's model is obtained using manual modeling, 3D scanning and model fitting.

17. A method according to claim 1, wherein a deep learning model that determines the sequence of actions/poses is applied to fill missing gaps in the synthesized game and deep learning techniques are used to apply character pose estimation and extract skeletal and skin pose features.

18. (canceled)

19. (canceled)

20. A system for controlling the rendering of a broadcasted game at a spectator side, comprising:
a) a set of cameras deploying around a real game field;
b) a memory for storing:
b.1) acquired video footages being a sequence of frames of said real game field and players in said real game;
c) a 3D model of each player, generated before said game according to the performance of said each player, within previously taken video streams;
d) an object detection module comprising at least one processor which is adapted to:
d.1) receive and processes said video footages;
d.2) identify said each player and said real game field in each frame of said video footages;
d.3) determine the location of each player on said game field in each frame;
d.4) extract skeletal and skin features of each player from said video footages using deep learning models;
d.5) generate 3D avatars for all players using said 3D model and said extracted features, to animate the respective 3D avatars;
d.6) continuously track the location and movements of each player over the acquired video footages;
d.7) determine pose features of each player over time;
e) a transmitter for transmitting data related to said game field, the location data and said 3D avatars to a software application at the spectator side; and
f) a computerized terminal device at the spectator side that executes said software application to thereby generate a synthesized game field and animate said 3D avatars according to pose features of each player.

21. (canceled)

22. A system according to claim 20, further comprising a VR user interface for allowing each spectator using the software application on his terminal device, to manipulate the rendering of said synthesized game by:
a) changing the point of view during the game;
b) changing the direction of view during said game;
c) stop and resume said game;
d) re-playing selected segments of said game;
e) controlling the zoom level to get close-up views from any direction and from any desired angle.

23. (canceled)

24. A system according to claim 20, in which the spectator at the client side views the 3D synthesized game on a 2D display screed, or by using a 3D VR goggle/smart glasses, or the 3D synthesized game without any intervention.

25. (canceled)

26. A system according to claim 20, in which the memory further stores an animation model for filling gaps of missing players from one or more video footage frames, to provide smooth animation of the avatars.

27. (canceled)

28. A system according to claim 20, in which the movements of every player is tracked over the available set of cameras, while selecting and the best view in terms of visibility and coherence. Deep learning techniques are used to apply character pose estimation and extract skeletal and skin pose features.

29. (canceled)

30. (canceled)

31. (canceled)

32. A system according to claim 20, comprising a transformer module which is adapted to:
a) receive a collection of features in each frame and translates said features to a pose of each player in each frame, thereby determining the poses variation over time;
b) output, for each frame, a skeletal representation of the pose of each player in that frame.

33. A system according to claim 20, in which the extracted pose features are compressed before being streamed to the remote spectators at the client side.

34. A system according to claim 20, in which the streaming architecture complies with:
a) HTTP specification;
b) Web Real-Time Communications (WebRTC);
c) HTTP Live Streaming (HLS);
d) Dynamic Adaptive Streaming over HTTP (MPEG-DASH).

35. (canceled)

36. A system according to claim 20, in which a deep learning model that determines the sequence of actions/poses is applied to fill missing gaps in the synthesized game.

37. (canceled)

38. A system according to claim 20, in which the terminal device is selected from the group of:
a smartphone;
a tablet;
a desktop computer;
a laptop computer;
a smart TV.
